(19) United States
(12) Patent Application Publication
(10) Pub. No.: US 2004/0103390 A1
(43) Pub. Date: May 27, 2004

(54) Software tool for formulating an automation task to be solved

(75) Inventor: Olav Gatzemeier, Gaggenau (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AG

(21) Appl. No.: 10/638,306

(22) Filed: Aug. 12, 2003

Related U.S. Application Data
(63) Continuation of application No. PCT/DE02/00474, filed on Feb. 8, 2002.

(30) Foreign Application Priority Data
Feb. 12, 2001 (DE) 101 06 397.0

(51) Int. Cl. G06F 9/44

(52) U.S. Cl. 717/120; 717/105; 717/114

(57) ABSTRACT

An automation tool for formulating an automation task to be solved, enabling the representation of automation functions in the form of objects on a display unit. These objects can be produced from a template and include at least one template-specific part and/or at least one object-specific part. The software tool is configured in such a way that a modification of template-specific parts (V1, V2, V3, Lv1, Lv2) in objects (Ob1_{—}01, Ob2_{—}01) is simplified, without any locally made adaptations being lost. The software tool modifies the template-specific parts (V1, V2, V3, Lv1, Lv2) in the objects (Ob1_{—}01, Ob2_{—}01) corresponding to the parts (Lv2, V5, Lv4, Lv5) modified in the template (Vo1) while preserving object specific parts (O1, O2, O3, O4, O5) that are specific to the objects (Ob1_{—}01, Ob2_{—}01), thereby producing modified objects (Obl_02, Ob2_02). Preferably, the software tool accomplishes this by assigning a modifiable part (V1, V2, V3, Lv1, Lv2) of the template (Vo1) a first identifier (Ka-Kh) and assigning the template (Vo1) and the objects (Ob1_{—}01, Ob2_{—}01) produced from this template (Vo1) a second identifier (K1, K2).

This is a Continuation of International Application PCT/DE02/00474, with an international filing date of Feb. 8, 2002, which was published under PCT Article 21(2) in German, and the disclosure of which is incorporated into this application by reference.

### FIELD OF AND BACKGROUND OF THE INVENTION

The invention relates to a software tool for formulating an automation task to be solved. The invention further relates to a method, and to a programming device with such a software tool. More specifically, the invention relates to such programming devices and software tools which enable automation functions to be represented as objects on a display unit.

Such a software tool is disclosed in Siemens Catalog ST 70, 2001 edition, chapter 8. There, various programming languages, e.g., programming languages in the form of Continuous Function Chart (CFC) or Sequential Function Chart (SFC), are provided in a programming device for formulating an automation task to be solved. These programming languages enable objects to be represented on a display unit of the programming device. The objects represent parts of a technical process to be controlled or parts of a system to be controlled. A plurality of objects can be produced from a template that is provided with template-specific parts, e.g., frequently occurring parts of the process. Using the so-called copy/modify concept, the template is first copied as many times as the number of the objects to be produced. Subsequently, each copy is supplemented with object-specific parts, i.e., with corresponding process parts adapted to the local requirements, to produce an object from each modified copy.

However, subsequent error corrections or functional expansions may make it necessary to change the template. This means that the changes must also be incorporated into the objects derived from this template.

### OBJECTS OF THE INVENTION

One of the objects of the present invention is to provide a software tool of the initially described type, which makes it easier to change the template-specific parts in objects. A further object is to define a programming device with such a software tool.

### SUMMARY OF THE INVENTION

These and other objects are attained by the invention, which, according to one formulation, is directed to a software tool for formulating an automation task to be solved, in the form of a programming language for automation devices, which enables automation functions to be represented as objects on a display unit. The software tool includes a component producing the objects from a template, wherein selected ones of the objects include at least one of a template-specific part and an object-specific part, an input unit modifying the template, and a component modifying the template-specific part in the selected objects corresponding to the part modified in the template.

It is advantageous that, through the invention, the templates can be created and modified centrally. The modifications automatically result in the objects that have been created from this template being modified, without the adaptations made on these objects based on local requirements being lost.

In one embodiment of the invention, each template, when created, is assigned a unique identifier, e.g., in the form of a so-called Universal Unique Identifier (UUID). This identifier is also assigned to each object created from this template, so that each object can be uniquely assigned to its template. In addition, each modifiable part of a template is also assigned a unique identifier. These identifiers make it possible to detect not only all the objects that are created from a given template but also the parts modified in the template, and consequently also the parts to be modified in the objects that are associated with this template. This makes it possible to match the modifications. Existing object-specifically adapted parts are thus preserved in the objects even though a template is modified.

### BRIEF DESCRIPTION OF THE DRAWINGS

The invention, including embodiments and advantages thereof, will now be described in greater detail with reference to an exemplary embodiment of the invention depicted in the drawing in which

FIGS. 1 and 2 show a CFC depiction of automation functions for solving an automation task,

FIGS. 3 and 4 show an SFC depiction of automation functions for solving an automation task, and

FIG. 5 shows a coding table.

### DETAILED DESCRIPTION OF THE PREFERRED EMBODIMENTS

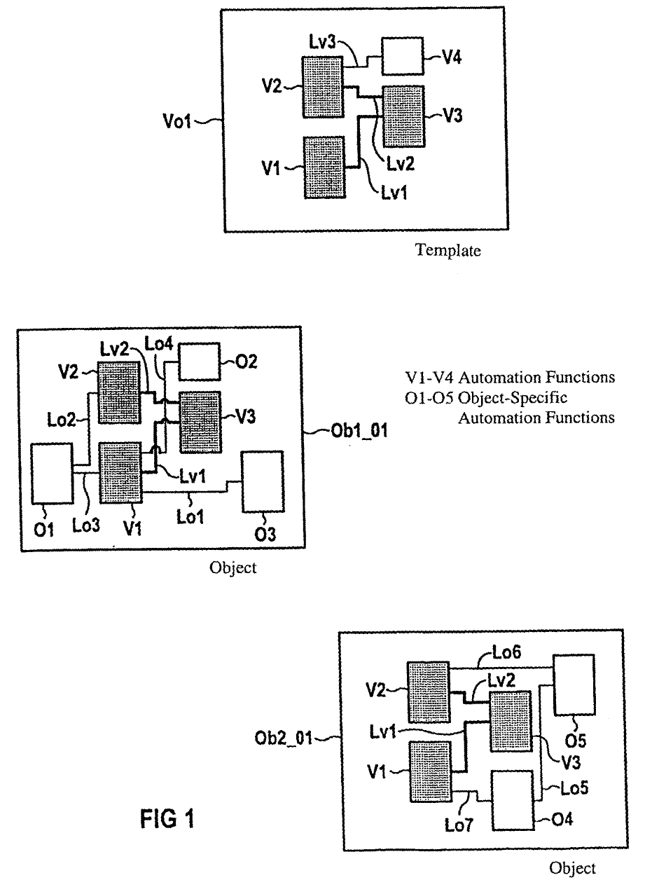

In FIG. 1 Vo1 identifies a template that can be created with a software tool and displayed on a display unit. This template has template-specific automation functions V1, V2, V3 and V4. The functions V1, V2 and V3 are operatively linked, as well as the functions V2 and V4, which in the figure is illustrated by respective lines Lv1, Lv2 and Lv3. It is assumed that the template-specific parts V1, V2, V3, Lv1 and Lv2 are to be capable of being modified centrally at a subsequent point in time. In the present example, this is indicated by the shading of the automation functions V1, V2 and V3 and by the thick lines Lv1 and Lv2. A user specifies which template-specific parts are to be modifiable in the template Vo1, e.g., by marking these parts using a control unit such as, e.g., a mouse.

The software tool detects such a marking and assigns these parts V1, V2, V3, Lv1 and Lv2 first identifiers. In addition to these first identifiers, the software tool generates a second identifier for the template Vo1 and for each copy of this template Vo1. In the present example, it is assumed that the template Vo1 is copied twice because the automation task to be solved requires two objects Ob1_01 and Ob2_01 to be created. These two objects have in common the template-specific parts V1, V2, V3, Lv1 and Lv2 of the template Vo1. In this example, the template-specific parts Lv2 and V4 are removed from the objects Ob1_01 and Ob2_01. The object Ob1_01 has, in addition to the template-specific parts, object-specific automation functions O1, O2, O3 and object-specific connecting lines Lo1, Lo2, Lo3 and Lo4. The object Ob2_01, in addition to the template-specific parts, is provided with the object-specific parts O4, O5 as well as Lo5, Lo6 and Lo7.

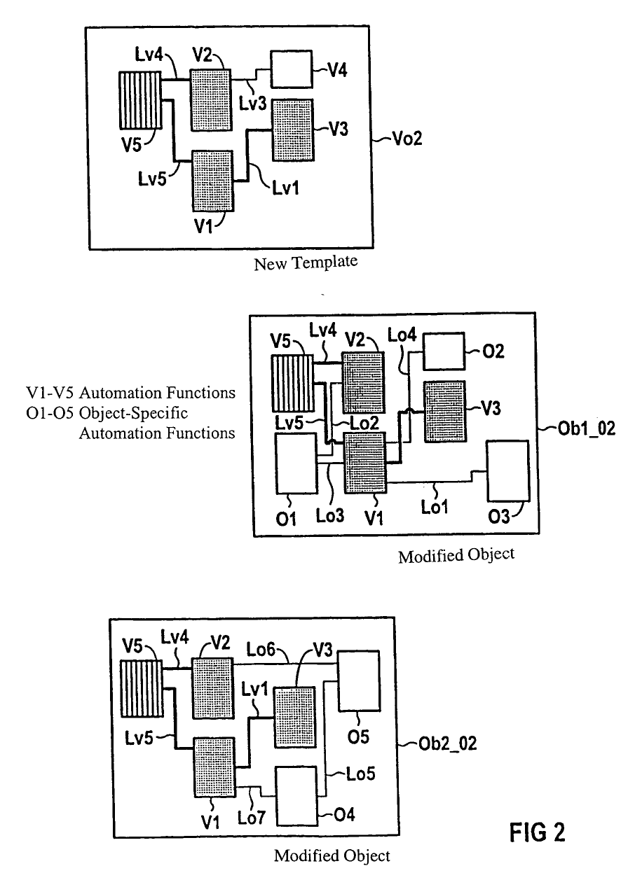

The following discussion assumes that the template Vo1 is modified in such a way that the connection Lv2 is deleted and a new template-specific automation function V5 and new connecting lines Lv4 and Lv5 are added to the template Vo1 to produce a new template Vo2. The new template is illustrated in FIG. 2. These new template-specific parts V5, Lv4 and Lv5 are again specially identified in the representation on the display unit, e.g., the automation function V5 is hatched and the connecting lines Lv4 and Lv5 are thick to indicate that these parts are, again, centrally modifiable and that the software tool assigns each of these parts a first identifier as described above.

Because of the second identifier that the software tool assigned the template Vo1 and the objects Ob1_01 and Ob2_01, the software tool detects that the objects Ob1_01 and Ob2_0l have template-specific parts of the template Vo1. Furthermore, because of the first identifier, which the software tool assigned the centrally modifiable template-specific parts, the software tool further detects which template-specific parts have changed in the template Vo2 as compared to the parts in the template Vo1. Based on these identifiers, the software tool carries out, in the objects Ob1_01 and Ob2_01, the template-specific changes that have been made in the template Vo1 to produce the modified objects Ob1_02 and Ob2_02. In the present example, these objects Ob1_02 and Ob2_02 thus have the template-specific automation functions V1, V2, V3 and V5 as well as the template-specific connections Lv1, Lv4 and Lv5 of the template Vo2. This means that, compared to the original template Vo1, the automation function V5 and the connections Lv4, Lv5 were added to the modified objects Ob1_01 and Ob2_01 while the connection Lv2 was deleted. The object-specific parts of the objects Ob1_01 and Ob2_01, the automation functions O1, O2, O3 as well as the connections Lo1, Lo2, Lo3, and the automation functions O4, O5, O6 as well as the connections Lo4, Lo5, Lo6 are preserved in the modified objects Ob1_02 and Ob2_02.

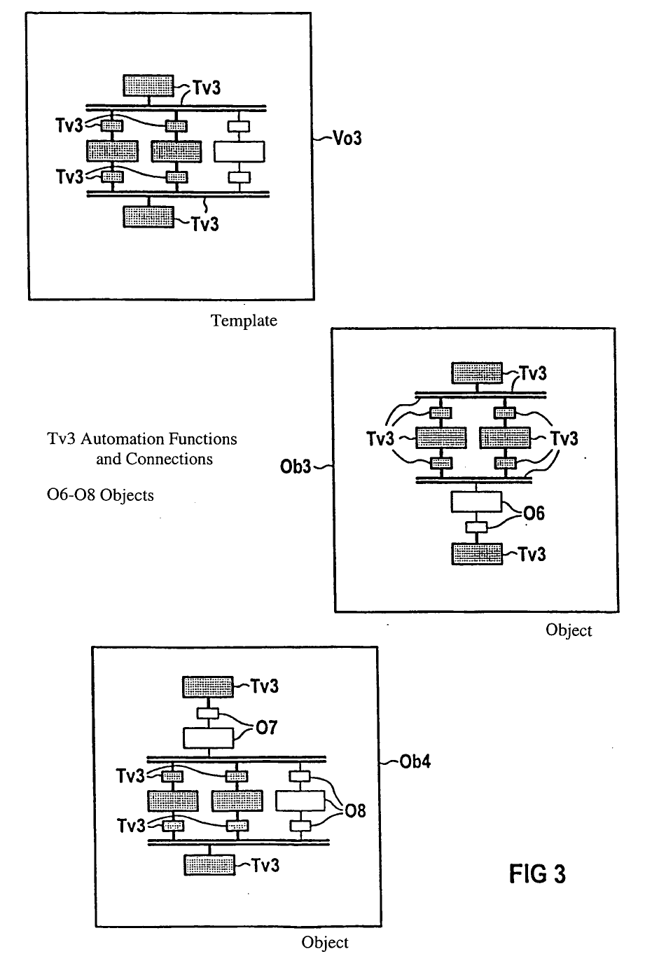

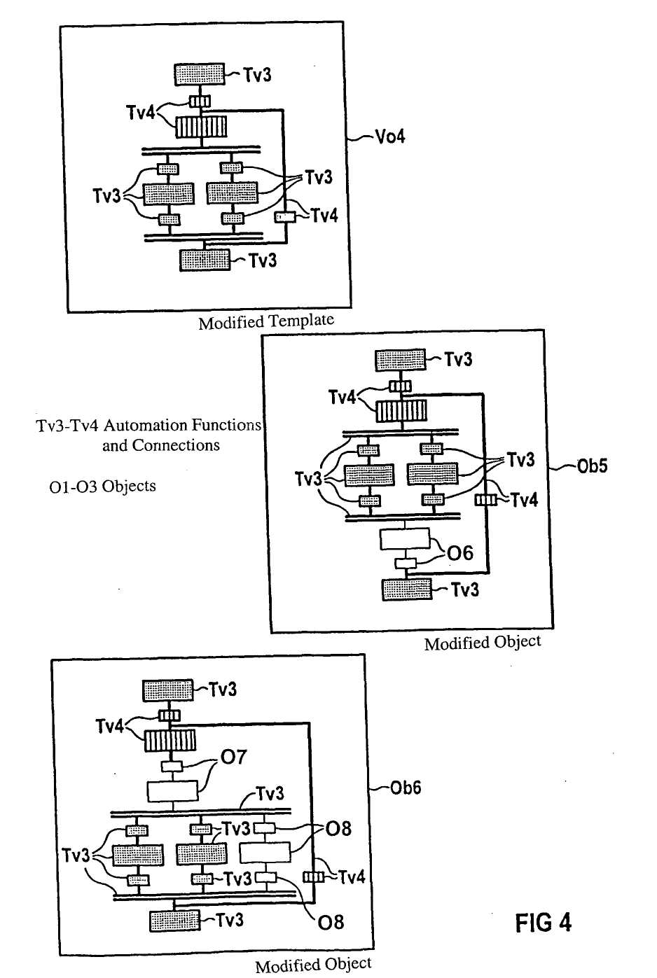

The following discussion makes reference to FIG. 3 and 4, which depict an SFC view of automation functions for solving an automation task. In the manner described above, modifiable automation functions and modifiable connections Tv3 in a template Vo3 can be marked on a display unit. The software tool assigns these parts Tv3 respective first identifiers. Furthermore, the software tool assigns objects Ob3, Ob4 that are created from the template Vo3 a second identifier. Based on these identifiers, the software tool modifies the objects Ob3, Ob4 corresponding to the modifications in the template Vo3. In the present example, the template Vo3 is modified in such a way that the template Vo3 is supplemented by parts Tv4 to produce a modified template Vo4. The software tool modifies the objects Ob3, Ob4 in the same manner, so that modified objects ObS, Ob6 are created, which include the template-specific parts Tv3, Tv4 of the template Vo4 without, however, losing the adapted parts O6, O7, O8.

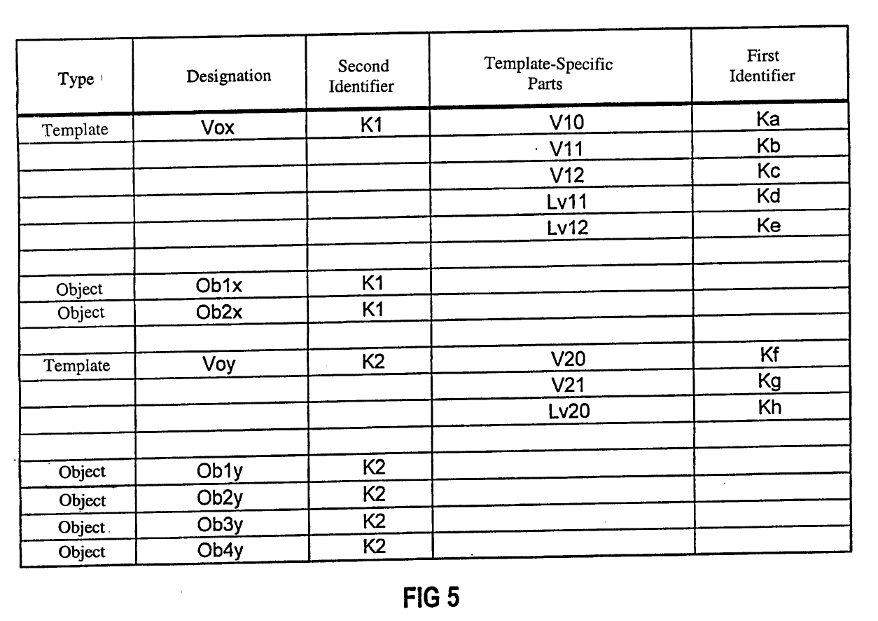

The following discussion makes reference to FIG. 5, which shows a coding table that is created by the software tool and modifiable by the software tool and is stored in a memory of a programming device. Templates Vox, Voy are entered in the table. The template Vox is provided with a second identifier K1 and the template Voy with a second identifier K2. The template Vox has template-specific parts V10, V11, V12, Lv11 and Lv12, which are each assigned a first identifier. In the present example, the template-specific part V10 is assigned an identifier Ka, the part V11 an identifier Kb, etc. . . . The table further shows that two objects Ob1x and Ob2x are derived from this template Vox because these objects Ob1x, Ob2x are also assigned the second identifier K1. Correspondingly, objects Ob1y, Ob2y, Ob3y and Ob4y are assigned second identifiers K2. This indicates that these objects were derived from a template Voy having the identifier K2. This template Voy has template-specific parts V20, V21 and Lv20 to which the software tool assigned first identifiers Kf, Kg and Kh.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A software tool for formulating an automation task to be solved, in the form of a programming language for automation devices, which enables automation functions to be represented as objects on a display unit, comprising:
a component producing the objects from a template, wherein selected ones of the objects include at least one of a template-specific part and an object-specific part,
an input unit modifying the template, and
a component modifying the template-specific part in the selected objects corresponding to the part modified in the template.

2. The software tool as claimed in claim 1, further comprising:
a component assigning a modifiable part of the template a first identifier, and
a component assigning the template and the objects produced from this template a second identifier,
wherein, if the modifiable part of the template is modified:
the modifying component uses the second identifier to detect the objects produced from the template, and uses the first identifier to detect the part in the detected objects that is assigned to the modifiable part of the template, and
the modifying component modifies the detected part of the objects corresponding to the modified part in the template.

3. A programming device comprising a software tool for formulating an automation task to be solved, in the form of a programming language for automation devices, which enables automation functions to be represented as objects on a display unit, said software tool comprising:
a component producing the objects from a template, wherein selected ones of the objects include at least one of a template-specific part and an object-specific part, an input unit modifying the template, and
a component modifying the template-specific part in the selected objects corresponding to the part modified in the template.

4. The programming device according to claim 3, said software tool further comprising:
a component assigning a modifiable part of the template a first identifier, and
a component assigning the template and the objects produced from this template a second identifier,
wherein, if the modifiable part of the template is modified:
the modifying component uses the second identifier to detect the objects produced from the template, and uses the first identifier to detect the part in the detected objects that is assigned to the modifiable part of the template, and the modifying component modifies the detected part of the objects corresponding to the modified part in the template.

5. A method comprising:
producing a plurality of templates of redundantly occurring portions of a technical process from template parts, at least one of the template parts being a modifiable template part;
assigning each template a respective unique template identifier and assigning each modifiable template part a unique part identifier;
using at least one of the templates to produce a plurality of objects representing respective phases of the technical process;
assigning each of the plurality of objects the respective unique template identifier of the at least one template used to produce the objects.

6. The method according to claim 5, further comprising:
when modifying the at least one modifiable template part, using the unique template identifier and the unique part identifier to automatically modify the plurality of objects.

7. The method according to claim 6, wherein the plurality of objects are modified, respectively, to incorporate the at least one modified template part while preserving respective non-modified object parts of the objects.
